(19) United States
(12) Patent Application Publication
(10) Pub. No.: US 2002/0065768 A1
(43) Pub. Date: May 30, 2002

(54) Contract-based electronic catalogs

(75) Inventors: Hendra Suwanda, Richmond Hill (CA); Yumman Chan, Rexdale (CA); Miu-to Brenda Lam, North York (CA)

Correspondence Address: A. Bruce Clay, IBM Corporation, T81/503, PO Box 12195, Research Triangle Park, NC, 27709, US

(73) Assignee: International Business Machines Corporation, Armonk, NY

(21) Appl. No.: 09/998,347

(22) Filed: Nov. 30, 2001

(30) Foreign Application Priority Data
Nov. 30, 2000 (CA) 2327156

(51) Int. Cl. G06F 17/60

(52) U.S. Cl. 705/37

(57) ABSTRACT

A computer system defines a set of electronic catalogs. The catalogs each have an associated contract and each user of the catalogs is associated with a contract. The set of catalogs is represented as a graph. Nodes in the graph represent contracts, catalogs, categories, products and prices. Edges in the graph are labelled with a catalog identifier or a contract identifier. The graph is traversed to display data to the user. The traversal of the graph by a given user is constrained so that the user's contract and catalog matches the edge labelling of the traversal.

### FIELD OF THE INVENTION

The present invention is directed to an improvement in computing systems and in particular to an improvement in systems for creating and maintaining electronic catalogs.

### BACKGROUND OF THE INVENTION

In electronic commerce (e-commerce) systems, it is typical for a seller to make product information available to buyers and potential buyers using a catalog. An electronic catalog is created and maintained by the seller, typically at the seller's site (often a website). A buyer or potential buyer may access the catalog using a browser and may obtain information and make purchases or enquiries, based on the information displayed in the catalogs.

The display of such catalog information may be tailored to the particular buyer who is browsing the electronic catalog of the seller. In many cases, a seller and a buyer will have negotiated a contract expressly which will govern the terms and conditions under which products and services are offered. For example, the range of products offered for sale by the seller and the prices at which the products are offered may be fixed by contract. Such is often the case with business to business e-commerce systems. In addition, there may be implicit contracts which exist and which are defined based on characteristics of the buyer and the requirements of the seller. For example, a preferred customer, an employee and an unrelated buyer may each have access to different products at different prices.

As is indicated above, different catalog information will be provided to different users, based on what contract (either express or implied) is in place between the seller and the buyer. Because there are potentially numerous contracts which may relate to a single product domain, the number of potential catalogs which a seller will maintain, may become large. In such a case, there may be constraints on the numbers of catalogs, based on the storage space available and the overhead required to maintain such multiple catalogs.

It is therefore desirable to have a contract based electronic catalog system which permits catalogs to be stored in an efficient manner and to permit simplified maintenance of such catalogs. It is desirable to have an electronic catalog system that permits different subsets of the product space to be made available to different buyers, without requiring multiple copies of data records to be maintained in the system.

### SUMMARY OF THE INVENTION

According to an aspect of the present invention there is provided an improved computer system for displaying and managing catalog and contract information.

According to another aspect of the present invention there is provided a computer system for defining a set of electronic catalogs for a defined product universe, each of the catalogs in the set having an associated contract, users of the electronic catalogs each being associated with one of the contracts, each catalog having a unique catalog identifier and each contract having a unique contract identifier, the computer system including

means for generating, storing and maintaining a graph representing the electronic catalogs,

each node in the graph containing data and

each edge in the graph connecting two nodes and being associated with one or more

catalog or contract identifiers,

means for traversing the graph in response to user requests, the traversal of the graph being constrained by the catalog or contract identifiers associated with the edges in the graph, and

means for displaying to the user the data at reached nodes in the graph traversal.

According to another aspect of the present invention there is provided the above computer system in which the nodes include contract nodes, catalog nodes, category nodes, product nodes and price nodes, in which

child nodes for a contract node comprise catalog nodes,

a catalog node may have alternatively, child category nodes or child product nodes,

child nodes for category nodes comprise product nodes,

child nodes for product nodes comprise price nodes.

and in which each parent node has a potential plurality of child nodes.

According to another aspect of the present invention there is provided the above computer system in which each edge between a contract node and a catalog node is associated with a catalog identifier, each edge between a catalog node and a category node is associated with a catalog identifier, each edge between a category node and a product node is associated with a catalog identifier and each edge between a product node and a price node is associated with a contract identifier.

According to another aspect of the present invention there is provided the above computer system in which the means for traversing the graph includes means for traversing an edge in response to a user request only when either the contract identifier for the contract with which a user is associated or the catalog identifier for the catalog with which the user's contract is associated matches the identifier associated with that edge in the graph.

According to another aspect of the present invention there is provided the above computer system in which each contract node includes associated contract information and time interval attributes, each product node includes an associated product identifier attribute, and each price node includes associated amount, currency and effective date attributes.

According to another aspect of the present invention there is provided the above computer system in which the graph is represented by a relational database table.

According to another aspect of the present invention there is provided the above computer system in which a catalog node may have child catalog nodes.

According to another aspect of the present invention there is provided the above computer system in which a category node may have child category nodes and in which each edge between a category node and a category node is associated with a catalog identifier.

According to another aspect of the present invention there is provided the above computer system further including a graphical user interface tool for presenting a master catalog to a catalog author and for permitting the catalog author to filter the nodes and edges in the master catalog and to define new nodes and edges to create a new catalog.

According to another aspect of the present invention there is provided a computer program product for defining a set of electronic catalogs, the computer program product including a computer usable medium having computer readable code means embodied in said medium, and including computer readable program code means for implementing the computer systems described above.

According to another aspect of the present invention there is provided a method for defining and displaying a set of electronic catalogs for a defined product universe, each of the catalogs in the set having an associated contract, users of the electronic catalogs each being associated with one of the contracts, each catalog having a unique catalog identifier and each contract having a unique contract identifier, the method including the following steps:

generating, storing and maintaining a graph representing the electronic catalogs,

each node in the graph containing data and

each edge in the graph connecting two nodes and being associated with one or more catalog or contract identifiers,

traversing the graph in response to user requests, the traversal of the graph being constrained by the catalog or contract identifiers associated with the edges in the graph, and

displaying to the user the data at reached nodes in the graph traversal.

According to another aspect of the present invention there is provided the above method in which the nodes comprise contract nodes, catalog nodes, category nodes, product nodes and price nodes, in which

child nodes for contract nodes comprise catalog nodes,

a catalog node may have alternatively, child category nodes or child product nodes,

child nodes for category nodes comprise product nodes,

child nodes for product nodes comprise price nodes.

and in which each parent node has a potential plurality of child nodes.

According to another aspect of the present invention there is provided the above method in which each edge between a contract node and a catalog node is associated with a catalog identifier, each edge between a catalog node and a category node is associated with a catalog identifier, each edge between a category node and a product node is associated with a catalog identifier and each edge between a product node and a price node is associated with a contract identifier.

According to another aspect of the present invention there is provided the above method in which the step of traversing the graph includes the step of comparing the contract identifier for the contract with which a user is associated or the catalog identifier for the catalog with which the user's contract is associated and the identifier associated with a reached edge in the graph and further includes the step of traversing that reached edge only when the comparison shows a match condition.

According to another aspect of the present invention there is provided a computer program product for defining and displaying a set of electronic catalogs, the computer program product including a computer usable medium having computer readable code means embodied in said medium, including computer readable program code means for carrying out the methods described above.

Advantages of the present invention include an efficient data representation of multiple catalogs for an e-commerce environment.

It will be appreciated by those skilled in the art that the computer program can be stored in storage or transmitted as a signal, such as on a modulated carrier signal for use in a computer system, or on a network such as the Internet for use in a computer system

### BRIEF DESCRIPTION OF THE DRAWINGS

FIG. 1 is a UML diagram showing the structure of catalogs defined according to the preferred embodiment.

FIG. 2 is a graph showing an example of catalog information stored in accordance with the preferred embodiment.

### DETAILED DESCRIPTION OF THE PREFERRED EMBODIMENT

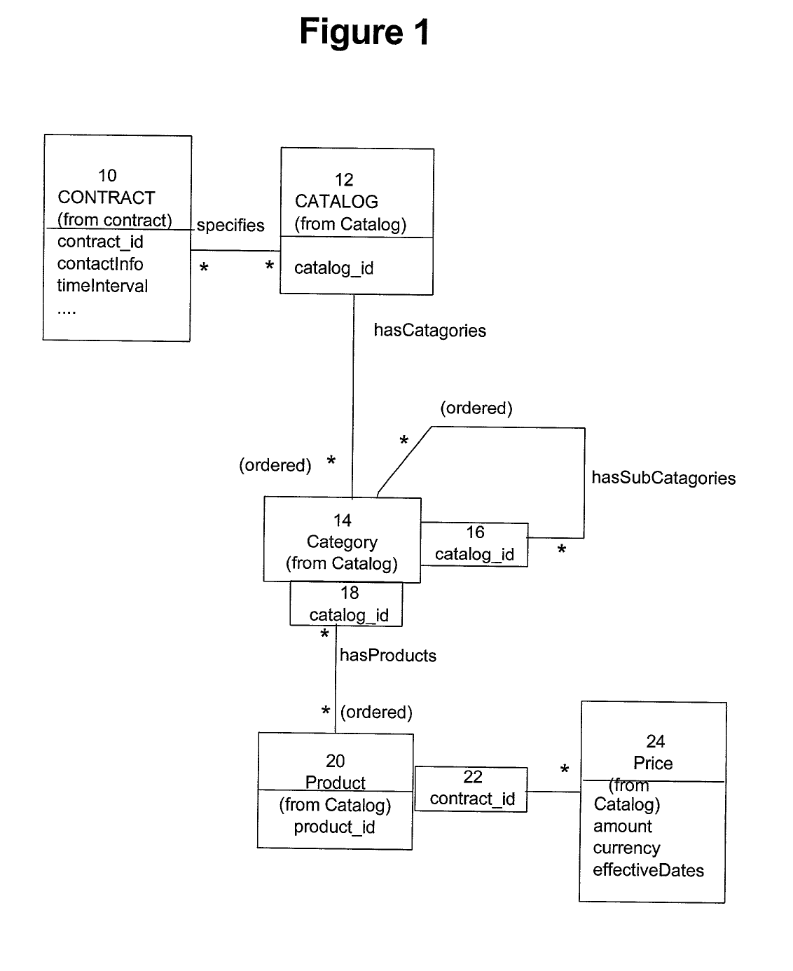

FIG. 1 is a UML diagram showing the structure of the preferred embodiment. The UML diagram shows contract 10. Contract 10 includes example attributes contract_id, contact info, and time interval. Contract 10 is shown specifying, in a many to many relationship, catalog 12. Catalog 12 has an associated catalog_id and is defined to have categories. The categories exist in a many to many relationship with catalog 14. Catalog 14 has associated catalog_id 16 and may have subcategories defined as categories in an ordered relationship. Category 14 is related to product 20 by catalog_id (shown as catalog 18). Product 20 has attribute product_id and is related to price 24 by contract_id (shown as contract_id 22).

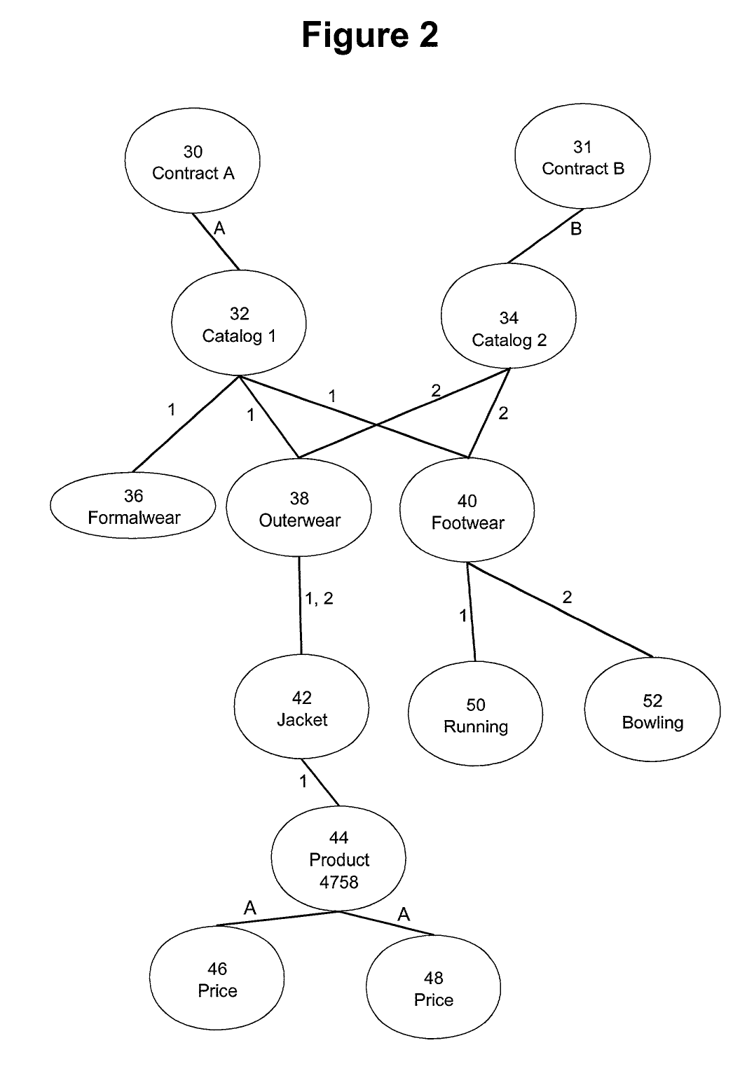

An example of an instance of the catalog structure of the preferred embodiment is shown in the graph of FIG. 2. FIG. 2 shows contracts 30, 31 having contract_id A and B, respectively). Catalogs 32, 34 are shown in FIG. 2 having catalog ids 1 and 2, respectively. The relationships between contract 30, catalog 32 and catalog 34 are shown by the connecting edges in the graph of FIG. 2. Contract 30 has an edge to catalog 32 identified by contract_id A). Similarly, contract 31 has an edge to catalog 34 marked with contract_id B. In FIG. 1, contracts are shown each having multiple potential catalogs. An alterntive appraoch is to define each contract to be associated with a single catalog. In such an arrangement it is advantageous to permit users to be associated with multiple contracts. This is typically the case as users may potentially seek to access the product domain or universe in different ways (an employee may also be a preferred customer, for example).

Catalogs 32, 34 are connected to category nodes 36, 38, 40 representing formalwear, outerwear and footwear, respectively. The edges between each of catalog 32 and catalog 34 and the category nodes in the graph are labelled by the catalog_id for the respective catalogs. In the example of FIG. 2, category 38 is shown having sub-category 42 representing jacket. The edge connecting category node 38 and sub-category node 42 is labelled with catalog_ids 1 and 2. Sub-category node 42 is connected to product node 44 by an edge labelled with catalog_id 1. Product node 44 has product_id 4758 in the example of FIG. 2. There are price nodes 46, 48 associated with product node 44. Both price nodes are connected to product node 44 by edges labelled with contract_id A. An example of where two prices are shown for the same product in a single catalog is where different currencies are listed. Another example is where the price attribute effectiveDates is compared with the contract attribute timeInterval to select between prices that may change over time.

FIG. 2 also shows contract node 31 having contract_id B. Contract B is associated with catalog 2 and FIG. 2 therefore shows an edge, labelled with contract_id B, between contract node 31 and catalog node 34. Catalog node 34 is connected to two category nodes, 38, 40. Category node 40 is connected to two sub-category nodes 50, 52 for running and bowling subcategories of footwear, respectively. FIG. 2 does not show products in these sub-categories but typically there will be further nodes below the two sub-category nodes 50, 52. As is shown in FIG. 2, sub-category node 50 is connected to category node 40 by an edge with catalog_id 1. Sub-category node 52 is connected to category node 40 by an edge with catalog_id 2.

As will be appreciated from the above description, it is possible for multiple catalogs and multiple contracts to define relationships with categories, products and prices which permit data to be stored in an efficient manner. The representation for the data may be implemented using different data structures. In the preferred embodiment, the data is maintained in a relational database in which the relationships between the various nodes as set out by the UML definition of FIG. 1, and represented by example in FIG. 2, are indicated by attribute values in the for records in the relational database.

The structure of FIG. 1 shows catalog 12 having category 14. In the preferred embodiment it is also possible for a catalog node to have no child category nodes. Where this is the case for a defined catalog, the catalog may have child product nodes. In such a catalog the edges from the catalog to the product nodes are labelled with the catalog_id of the catalog node. This alternative arrangement is not shown directly in FIG. 1. In the preferred embodiment, if a catalog node has a child category node, then all the child nodes of that catalog node are category nodes. This arrangement is suitable for a catalog for a limited product domain or universe. There may not be a need to arrange products in categories for such an application of the preferred embodiment.

As will be seen from the example of FIG. 2, navigation between the catalog pages is constrained by the edges and edge label values shown in the graph of FIG. 2. In this way, a buyer having access to a page in the electronic catalog corresponding to category node 38 (outerwear) will be able to reach sub-category 42 (jacket) if the buyer is given access to catalog 1 or catalog 2 as defined by catalog nodes 32, 34. As is shown in FIG. 2, by example, a buyer under contract 30 (contract_id A) is able to access catalog pages about product 44 and prices 46, 48. Other users accessing the data from other contracts will see a different catalog. For example a buyer under contract 31 (contract_id B) has access to catalog 34, will therefore have catalog access to footwear catgegories but not formalwear. This is due to catalog node 34 having edges to category nodes 38, 40 but not to node 36.

Another example of how navigation is constrained by the system of the preferred embodiment is shown with reference to node 40. This category (footwear) is reachable by buyers accessing either catalog 1 or 2 (node 40 is reachable from either node 32 or node 34). However, the two catalogs include different subcategories for the footwear category. The edge labels between node 40 and nodes 50, 52 indicate that a buyer using catalog 1 will have access only to the running footwear subcategory whereas a buyer using catalog 2 will have access to only the bowling footwear subcategory. This is defined in the graph of FIG. 2 by the edge to subcategory node 50 being labelled with catalog_id 1 and the edge to subcategory node 52 being labelled with catalog_id 2. By building a logical structure on top of the product universe duplications of product data may be reduced and multiple contracts may be defined without causing unsupportable increases in data storage.

Although the structure shown in FIG. 1 for the preferred embodiment is defined in terms of contracts, it is possible to have a contract which corresponds to such buyer characteristics as country of origin, language or other characteristics of a user. In such cases the contract as defined in FIG. 1 may not be an express contract between parties but rather to be an implied set of conditions that apply to a buyer or a potential buyer.

As indicated in the structure of FIG. 1, the design of all catalogs is defined uniformly. As a result, contracts may be defined recursively to create a sub-contract with an associated sub-catalog within an existing contract and catalog relationship. Although this is not shown expressly in FIG. 1, the structure is similar to that shown for the definition of sub-categories in the category definition shown in FIG. 1.

In the preferred embodiment, each of contract catalog, category, product and price relationship is defined in the following way. A contract administrator will create a new contract between a seller and buyer. The duration of the contract, the creation of a contracted catalog and the assignment of contracted prices for the catalog entries are defined by the contract administrator. Typically a seller organization defining a set of catalogs on a site will own a master catalog on which a new contracted catalog will be based. A contract administrator will filter the desired products and categories which make up the new contracted catalog. In the preferred embodiment a graphical user interface filtering tool is provided to permit the contract administrator to set up the new contracted catalog.

Once the catalog is created, a contract administrator (or price administrator) may assign contracted prices for each product in the newly created catalog.

As indicated above, in the preferred embodiment, the data representing a particular set of catalogs is stored in a relational database form. The system of the preferred embodiment permits users to generate the relationships between products, categories, catalogs and contracts and as these relationships are defined, entries are created in the relational database relating to the product universe in question. As will be appreciated by those skilled in the art, there are different ways in which the structure defined in FIG. 1 may be implemented. As will also be appreciated, the addition of a new catalog to a given system will not necessarily require the redefinition of products, prices and categories but will require the addition of new edges and/or relabelling of existing edges.

Although a preferred embodiment of the present invention has been described here in detail, it will be appreciated by those skilled in the art that variations may be made thereto without departing from the spirit of the invention or the scope of the appended claims.

The embodiments of the invention in which an exclusive property or privilege are claimed are defined as follows:

1. A computer system for defining a set of electronic catalogs for a defined product universe, each of the catalogs in the set having an associated contract, users of the electronic catalogs each being associated with one of the contracts, each catalog having a unique catalog identifier and each contract having a unique contract identifier, the computer system comprising
means for generating, storing and maintaining a graph representing the electronic catalogs,
each node in the graph containing data and
each edge in the graph connecting two nodes and being associated with one or more catalog or contract identifiers,
means for traversing the graph in response to user requests, the traversal of the graph being constrained by the catalog or contract identifiers associated with the edges in the graph, and
means for displaying to the user the data at reached nodes in the graph traversal.

2. The computer system of claim 1 in which the nodes comprise contract nodes, catalog nodes, category nodes, product nodes and price nodes, in which
child nodes for contract nodes comprise catalog nodes,
a catalog node may have alternatively, child category nodes or child product nodes,
child nodes for category nodes comprise product nodes,
child nodes for product nodes comprise price nodes.
and in which each parent node has a potential plurality of child nodes.

3. The computer system of claim 2 in which each edge between a contract node and a catalog node is associated with a catalog identifier, each edge between a catalog node and a category node is associated with a catalog identifier, each edge between a category node and a product node is associated with a catalog identifier and each edge between a product node and a price node is associated with a contract identifier.

4. The computer system of claim 3 in which the means for traversing the graph comprises means for traversing an edge in response to a user request only when either the contract identifier for the contract with which a user is associated or the catalog identifier for the catalog with which the user's contract is associated matches the identifier associated with that edge in the graph.

5. The computer system of claim 2 in which each contract node comprises associated contract information and time interval attributes, each product node comprises an associated product identifier attribute, and each price node comprises associated amount, currency and effective date attributes.

6. The computer system of claim 1 in which the graph is represented by a relational database table.

7. The computer system of claim 2 in which a catalog node may have child catalog nodes.

8. The computer system of claim 2 in which a category node may have child category nodes and in which each edge between a category node and a category node is associated with a catalog identifier.

9. The computer system of claims 1, 2, 3 or 4 further comprising a graphical user interface tool for presenting a master catalog to a catalog author and for permitting the catalog author to filter the nodes and edges in the master catalog and to define new nodes and edges to create a new catalog.

10. A computer program product for defining a set of electronic catalogs, the computer program product comprising a computer usable medium having computer readable code means embodied in said medium, and comprising computer readable program code means for implementing the computer system of claims 1, 2, 3, 4, 5, 6, 7 or 8.

11. A method for defining and displaying a set of electronic catalogs for a defined product universe, each of the catalogs in the set having an associated contract, users of the electronic catalogs each being associated with one of the contracts, each catalog having a unique catalog identifier and each contract having a unique contract identifier, the method comprising the following steps:
generating, storing and maintaining a graph representing the electronic catalogs,
each node in the graph containing data and
each edge in the graph connecting two nodes and being associated with one or more catalog or contract identifiers,
traversing the graph in response to user requests, the traversal of the graph being constrained by the catalog or contract identifiers associated with the edges in the graph, and
displaying to the user the data at reached nodes in the graph traversal.

12. The method of claim 11 in which the nodes comprise contract nodes, catalog nodes, category nodes, product nodes and price nodes, in which
child nodes for a contract node comprise catalog nodes,
a catalog node may have alternatively, child category nodes or child product nodes,
child nodes for category nodes comprise product nodes,
child nodes for product nodes comprise price nodes.
and in which each parent node has a potential plurality of child nodes.

13. The method of claim 12 in which each edge between a contract node and a catalog node is associated with a catalog identifier, each edge between a catalog node and a category node is associated with a catalog identifier, each edge between a category node and a product node is associated with a catalog identifier and each edge between a product node and a price node is associated with a contract identifier.

14. The method of claim 13 in which the step of traversing the graph comprises the step of comparing the contract identifier for the contract with which a user is associated or the catalog identifier for the catalog with which the user's contract is associated and the identifier associated with a reached edge in the graph and further comprises the step of traversing that reached edge only when the comparison shows a match condition.

15. A computer program product for defining and displaying a set of electronic catalogs, the computer program product comprising a computer usable medium having computer readable code means embodied in said medium, comprising computer readable program code means for carrying out the method of claims 11, 12, 13, or 14.

16. The computer program product of claim 15 wherein said computer readable code means comprises a computer readable signal and said medium comprises a computer readable signal-bearing medium.

17. The program product of claim 1$ wherein said medium is a recordable data storage medium.

18. The product of claim 17 wherein said medium is a modulated carrier signal.

19. The product of claim 18 wherein said signal is a transmission over a network.

20. A computer program comprising computer program code means adapted to perform all the steps of claims 11, 12, 13, or 14 when said program is run on a computer system.
